(19) United States
(12) Patent Application Publication
(10) Pub. No.: US 2020/0090160 A1
(43) Pub. Date: Mar. 19, 2020

(54) Time Limited Code

(71) Applicant: Mobile Technology Holdings Limited, Douglas (GB)

(72) Inventors: Sean Anthony Edmiston, Melrose Park (AU); Peter David Wilson, Waverton (AU)

(73) Assignee: Mobile Technology Holdings Limited, Douglas (GB)

(21) Appl. No.: 16/585,783

(22) Filed: Sep. 27, 2019

Related U.S. Application Data
(63) Continuation of application No. 14/774,740, filed on Sep. 11, 2015.
(60) Provisional application No. 61/779,207, filed on Mar. 13, 2013.

(51) Int. Cl. G06Q 20/32; G06Q 20/20; G06Q 20/42; G06Q 20/38; G07C 9/00; H04L 29/06

(52) U.S. Cl. CPC G06Q 20/3274; G06Q 20/204; G06Q 20/425; H04L 63/0846; G06Q 20/3255; G07C 9/00023; G06Q 20/3821; G06Q 20/385

(57) ABSTRACT

A method including authenticating a voucher which has a time limited validity period. The method comprises: a user requesting issuance of a token to a customer in a machine readable form; and issuing one or more modified versions of the token to the user, each modified version of the token being associated with a different time period of validity of the token; scanning the ticket on a scanning device connected to a terminal operated by the user; the scanning device modifying the token according to a current time period; and the terminal operated by the user comparing the modified token provided by the scanner with the modified tokens issued by the central server to validate the scanned token. A further method is provided for performing a transaction, between a customer and a vendor, using a customer's mobile phone as an authorisation device. The further method comprises: a requesting a payment authorisation and receiving a single use authorisation code from the financial service provider which displays on the customer's mobile phone as an optically readable image; and the customer scanning the optically readable image on an optical scanning device to authorise the transaction.

### CROSS-REFERENCE TO RELATED APPLICATIONS

This application is a continuation of U.S. application Ser. No. 14/774,740 filed on Sep. 11, 2015, which is the national stage of International Patent Application No. PCT/AU2014/000259 filed on Mar. 13, 2014, which claims priority to U.S. Provisional Application No. 61/779,207 filed on Mar. 13, 2013, all of which are hereby incorporated by reference in their entireties as if fully set forth herein.

### BACKGROUND

### 1. Field

The present invention relates to the use of scannable codes and in particular the invention provides improved methods of using scannable codes transmitted to mobile devices to enable various types of transaction to be completed.

### 2. Related Art

Mobile phones are becoming central to everyday life and with the extensive use of smartphones with their extensive and expanding libraries of custom applications and increasing functionality, phone users are using their phones to enable a variety of financial and other transactions and functions, such as point of sale payments, airline boarding passes etc. Existing systems for point of sale and other transactions rely on specific features of consumer handsets such as a high resolution screen for the display of 1 and 2d barcodes or the presence of a specific hardware device such as an NFC chip to enable Near Field Communications technology. Use of devices such as phones to perform financial transactions has a security benefit as it removes the need for the customer to carry one or more credit cards which have a reputation for being easily copied by unscrupulous vendors or thieves who surreptitiously replace card scanning devices with skimming devices to harvest card details of unwitting card holders. Phones allow transaction protocols that can defeat the skimming practices that have become widespread.

But despite the growing popularity of smartphones there are still many people using older mobile phones with limited functionality and text only displays. However one capability that such older phones almost universally include is the ability to send and receive messages via the Short Message Service (SMS) function built into mobile phone systems. Recently SMS has been used to transmit text based scannable codes for some transaction types such as mobile ticketing and airline check-in, allowing these transaction types to be performed using not just smartphones, but any mobile phone. However security and other issues exist which have prevented the expansion of usage of such systems to other transaction types such as cash payments.

Security issues also exist for all types of token (Credit Cards, tickets, vouchers, etc.) that are issued and remain unchanged through their life. Such tokens can be stolen and used fraudulently (or used fraudulently by the original holder) particularly when the token has a limited period of validity or is a single use token.

One common way of limiting the duration over which a particular token is valid, is to encode a time range into the ‘token’ itself. This has the disadvantage that tokens cannot be extended with being changed. Another common way of doing this is to have the start and end times stored on a server. When the token is generated it is simply used as a key to lookup the start and end times on the server. The disadvantage of this is that all scanning devices must be connected to the same central server at the time the token is scanned.

### SUMMARY

According to a first aspect, a method is provided for authenticating a voucher which has a time limited validity period, the method comprising:

a user requesting issuance of a token to a customer from a central server;

the central server issuing the token directly or indirectly to the customer and issuing one or more modified versions of the token to the user, each modified version of the token being associated with a different time period of validity of the token, and the token received by the customer being provided in a machine readable form;

the user loading the modified codes into a terminal operated by the user;

the customer scanning the ticket on a scanning device connected to the terminal operated by the user;

the scanning device modifying the token according to a current time period and providing the modified token to a terminal operated by the user; and

the terminal operated by the user comparing the modified token provided by the scanner with the modified tokens issued by the central server and if the modified token provided by the scanner matches a token issued by the central server, the terminal operated by the user indicates that the scanned token is valid.

According to a second aspect, a method is provided for authenticating a voucher which has a time limited validity period, the method comprising:

a central server receiving a request from a user to issue of a token to a customer;

the central server issuing the token directly or indirectly to the customer and issuing one or more modified versions of the token to the user, each modified version of the token being associated with a different time period of validity of the token, and the token received by the customer being provided in a machine readable form, such that:

the user may load the modified codes into a terminal operated by the user;

the customer may scan the ticket on a scanning device connected to the terminal operated by the user;

the scanning device may modify the token according to a current time period and providing the modified token to a terminal operated by the user; and

the terminal operated by the user may compare the modified token provided by the scanner with the modified tokens issued by the central server and if the modified token provided by the scanner matches a token issued by the central server, the terminal operated by the user may indicate that the scanned token is valid.

According to a third aspect, a method is provided for authenticating a voucher which has a time limited validity period, the method comprising:

a user requesting issuance of a token to a customer from a central server, such that the central server issues the token directly or indirectly to the customer and issues one or more modified versions of the token to the user, each modified version of the token being associated with a different time period of validity of the token, and the token received by the customer being provided in a machine readable form;

the user loading the modified codes into a terminal operated by the user and having a scanning device operatively connected thereto, such that the customer may scan the ticket on the scanning device connected to the terminal operated by the user and the scanning device modifies the token according to a current time period and provides the modified token to a terminal operated by the user; and

the terminal operated by the user comparing the modified token provided by the scanner with the modified tokens issued by the central server and if the modified token provided by the scanner matches a token issued by the central server, the terminal operated by the user indicates that the scanned token is valid.

The period of validity of a token may be for the duration of a single event (e.g. theatre performance, movie or a single sporting event) or may be a broad period of time such as a day, a week, or a month (e.g. travel tickets) or a year (e.g. a season sports ticket) during which the token may be used a plurality of times.

The user may be a vendor's point of sale system or user sales server. The process may be initiated by operation of a point of sale terminal connected to the user sales server, an online transaction with an online shop via a computer or portable device connected to the users sales server via the internet, or the customer initiating a transaction at vending machine (e.g. train ticket vending machine) connected to the user sales server,

When the token is a ticket for entry or travel, the scanner may optionally be connected to an entry barrier or turnstile, such that scanning a valid ticket will release the turnstile for entry. When the token is a discount voucher or gift certificate the scanner will pass the token to a point of sale system where it will cause a credit to be created in relation to a transaction being processed on the point of sale system.

According to a fourth aspect, a method is provided for performing a transaction, between a customer and a vendor, using a customer's mobile phone as an authorisation device, the method comprising:

a customer placing a request for a payment authorisation with a financial service provider;

the customer receiving a single use authorisation code from the financial service provider on the customer's mobile phone, and the authorisation code displaying on the customer's mobile phone as an optically readable image; and

the customer scanning the optically readable image on an optical scanning device associated with a vendor's payments terminal to authorise the transaction, enabling the single use authorisation code to be communicated to a settlement service for settlement of the transaction.

According to a fifth aspect, a method is provided for authorising a transaction, between a customer and a vendor, using a customer's mobile phone as an authorisation device, the method comprising:

a financial service provider receiving a request for a payment authorisation from a customer;

the financial service provider transmitting a single use authorisation code to the customer's mobile phone and the authorisation code displaying on the customer's mobile phone as an optically readable image; and

the financial service provider receiving the single use authorisation code from a settlement service to which it is communicated for settlement of the transaction after it has been scanned on an optical scanning device associated with a vendor's payments terminal to authorise the transaction.

According to a sixth aspect, a method is provided for settling a transaction, between a customer and a vendor, using a mobile phone as an authorisation device, the method comprising:

a settlement service receiving transaction details from the vendor, including a single use authorisation code received from the financial service provider by the customer wherein the authorisation code is displayed on the customer's mobile phone as an optically readable image and scanned on an optical scanning device associated with a vendor's payments terminal to authorise the transaction; and

the settlement service sending the transaction details including the authorisation code and customer identification to the financial service provider to validate the transaction for settlement and settling the transaction.

According to a seventh aspect, a system is provided for authenticating a token which has a time limited validity period comprising:

a server; and

a user terminal associated with a user;
wherein the server is configured to:

receive a request requesting issuance of a token to a customer; and

issue a machine readable customer token directly or indirectly to the customer in response to receiving the request and issue one or more modified versions of the token to the user, each modified version of the token being associated with a different time period of validity of the token; and
wherein the user terminal is configured to:

store the one or more modified versions of the token;

receive a scanning device token from a scanning device that is derived from the customer token;

compare the scanning device token with the one or more modified versions of the token; and

indicate that the scanning device token is valid if the scanning device token matches at least one of the one or more modified versions of the token.

According to an eight aspect, a server is provided comprising at least one processor and at least one memory operatively associated with the at least one processor, the server programmed to:

receive a request requesting issuance of a token to a customer; and

issue a machine readable customer token directly or indirectly to the customer in response to receiving the request and issue one or more modified versions of the token to a user terminal, each modified version of the token being associated with a different time period of validity of the token.

According to a ninth aspect, a user terminal is provided comprising at least one processor and at least one memory operatively associated with the at least one processor, the user terminal programmed to:

receive one or more modified tokens from a server, the one or more modified tokens derived from a customer token, each modified version of the token being associated with a different time period of validity of the token;

store the one or more modified tokens;

receive a scanning device token from a scanning device that is derived from the customer token;

compare the scanning device token with the one or more modified tokens; and

indicate that the scanning device token is valid if the scanning device token matches at least one of the one or more modified tokens.

According to a tenth aspect, a scanning device is provided comprising at least one processor and at least one memory operatively associated with the at least one processor, the scanning device configured to:

scan a customer token;

modify the scanned customer token according to a current time period; and

provide the modified token to a user terminal.

The settlement service may settle the transaction by arranging a funds transfer from the financial service provider to the vendor. The funds transfer may be from the financial service provider to a vendor's account at a financial institution.

The transmission of the request for the payment authorisation may be performed by the customer to the financial service provider from the customer's mobile phone, using an SMS message, but may also be transmitted as an email message as text or an attachment, by a message sent via Unstructured Supplementary Service Data (USSD) or via a web application running on a smart phone and accessing a secure server. The authorisation code may be a text based code such as a encoded character string (described below) sent via SMS, USSD, email or via a web server and web application, but may also be a conventional 1D or 2D barcode displayed on a smartphone and transmitted as an attachment to an SMS, MMS message, an email or communicated to and displayed by a web application in communication with a web server.

The request may include a maximum transaction value that the customer wishes to authorise. This may be the exact amount of the proposed transaction but might also be a rounded up value (e.g. the transaction may be for an amount of $139 but the authorisation request might be for $150). In response to the payment authorisation request the financial service provider will confirm the identity of the customer by way of the phone number from which the request was received (for SMS, MMS and USSD messages) or by other confidential identification (for email and other smart phone applications). If the customer identification corresponds to a valid account and the request falls below the maximum transaction limit for the account, the financial service provider will send an authorisation to the customer containing the single use authorisation code. The authorisation code may only be used for one transaction and so in the event that the transaction amount is less than the authorisation value the surplus authorisation value will be void and cannot be used for a further transaction. The authorisation code may also have a restricted period of validity (e.g. 1 minute) to minimise the possibility of fraudulent use and may also include the maximum value of the authorised transaction, which may be used by the payments terminal to restrict the transaction value it will accept. p The vendor will enter the transaction details into a payments terminal as for other payment devices such as a credit or debit card (or the details will be transferred electronically from the cash register) and the customer will scan the authorisation code (displayed on the customer's phone) into the payments terminal via a dedicated optical scanning window and enters a personal identification code such as a Personal Identification Number (PIN), biometric identifier etc., as with other transaction devices. The transaction details will then be transmitted from the payment terminal to the settlement service. The settlement service will then send the single use authorisation code to the financial service provider to validate the transaction, allowing the transaction to be settled, such as by direct transfer of funds from the financial service provider into a specified account of the vendor at a financial institution.

Communication between the financial service provider and the customer and between the vendor and the settlement service may be via an intermediary service provider, in which case the intermediary service provider may provide an encoding service whereby it receives an authorisation code from the financial service provider and codes it in an optically readable image format that is appropriate for the type of mobile phone used by the customer. The intermediary service provider may also decode messages from the user's phone before relaying them to the financial service provider. The payment terminal or the optical scanning device may decode the optically displayed image of the authorisation code to reveal the original authorisation code created by the financial service provider before adding it to the transaction data transmitted to the settlement service.

The settlement service may also send a receipt to the customer (possibly through the intermediary service provider) and may show details such as the vendor, the transaction number and amount of the transaction.

Further aspects of the disclosure are apparent from the description below, and from the claims.

Embodiments of the invention will now be described with reference to the accompanying drawings.

### BRIEF DESCRIPTION OF THE DRAWINGS

FIG. 1 is schematic diagram of a transaction pathway for a transaction between a customer and a vendor when the customer is using a phone which can only display text;

FIG. 2 is a schematic diagram of a client device display illustrating two types of authorisation code;

FIG. 3 is a schematic diagram of a client device display illustrating a type of authorisation code; and

FIG. 4 is a flow chart illustrating the assembly of an authorisation code from an original transaction number;

FIG. 5 is a schematic diagram of the transaction pathway of FIG. 1 for a transaction between a customer and a vendor when the customer is using a smart phone which can display graphic images;

FIG. 6 is a schematic diagram of equipment at a point of sale and its interconnection with the financial services network; and

FIG. 7 is a schematic diagram of a system including a central server that issues a token to fulfill a purchase by a customer from a vendor user.

### DETAILED DESCRIPTION OF THE ILLUSTRATIVE EMBODIMENTS

A payment system is proposed which uses messages sent to a mobile phone as a means of authenticating a purchase transaction, whereby the customer receives a code from a financial institution which is displayed on the screen of the customer's phone and the customer scans the code on a scanner associated with a vendor's payments terminal. The code may be an encoded text message which is formatted to be read by a dedicated optical scanner and will be processed by a payments terminal on the vendor's premises to retrieve the code from a scanned image of the coded message. Alternative coding methods may make use of a conventional 1D or 2D barcode or other optical code representation which can encode the message. However when display of the optically represented encoding requires a graphic display device, rather than merely a character only display device, its use will be restricted to mobile phones having such a graphic display capability. In one possible embodiment the messages sent to a mobile phone of the customer is sent via SMS and may be displayed on any type of mobile phone as a text string. But other types of message are also possible and different message types may be used in one system to communicate with different phone types by selecting an appropriate message type according to the customer's type of mobile phone.

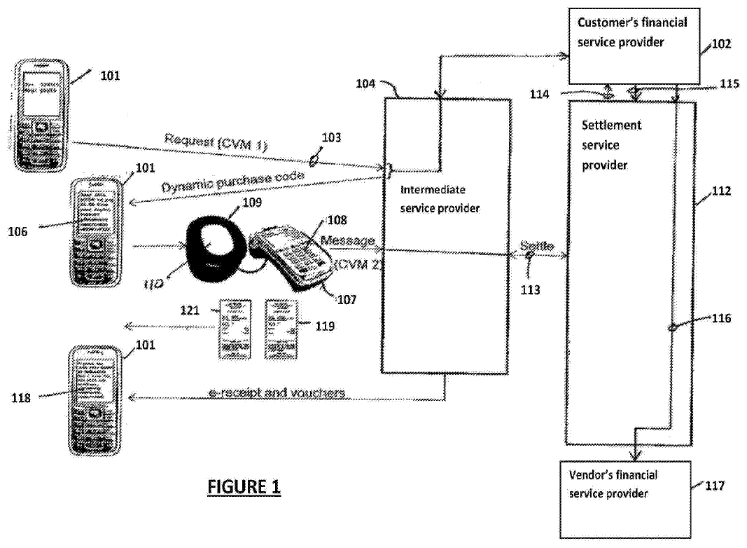

Referring to FIG. 1, a schematic diagram of a purchase transaction pathway is illustrated using messages sent to the customer's mobile phone 101 by SMS message. When a customer wishes to complete a purchase transaction with a vendor, the customer contacts their financial institution 102 to request a payment authorisation. When using SMS, this will typically be done via an SMS message 103 which may optionally contain the maximum value of the requested payment authorisation and may involve an intermediate service provided by an intermediate service provider 104 such as the phone company or other service provider. The maximum transaction value may be the exact amount of the proposed purchase transaction but might also be a rounded up value (e.g. the purchase transaction may be for an amount of $139 but the authorisation request might be for $150). Alternatively a maximum value might not be included in the request 103 and timing constraints may be used to minimise the possibility of fraudulent use. In response to the payment authorisation request 103 the financial service provider 102 will confirm the identity of the customer by way of the phone number from which the request was received (for SMS, MMS and USSD messages) or by other confidential identification (for email and other smart phone applications). If the customer identification corresponds to a valid account and the request falls below the maximum transaction limit for the account, the financial service provider 102 will send an authorisation message 105 to the customer's mobile phone 101 containing the single use authorisation code. The authorisation code may only be used for one transaction and so in the event that the purchase transaction amount is less than the authorisation value the surplus authorisation value will be void and cannot be used for a further transaction. In this example the payment system of the financial institution will respond with a single use code also sent by SMS message 105 and displayed on the phone as an optically readable character string 106 as will be described in greater detail below. However as mentioned above, other optically readable code types such as 1D and 2D barcodes may also be used.

The vendor will enter the purchase transaction details into a payments terminal 107 as they would for other payment devices such as a credit or debit card using the keyboard 108 (or the details will be transferred electronically from a cash register not shown) and once the payments terminal is ready it will indicate to the customer to present the authorisation code to the scanner 109. Indication that the payments terminal is ready to receive a scanned authorisation code may be by lighting scanning lights within the scanning window 110 of the scanner 109. It is at that time that the customer will generally request the authorisation from the financial service provider, as if it is requested too early it may expire before the payment terminal is ready to scan the customer's phone 101. Once the SMS containing the authorisation code has been received on the customer's phone 101 and displayed 106, the customer must place the phone 101 face down with the display of the phone against the reader window 109 of the optical code scanning device 110, which reads the optically readable character string 106 received in the SMS (and must be still displayed on the phones display screen) and converts the optically readable image into the original single use authorisation code issued by the financial institution.

The authorisation code 106 may also have a restricted period of validity (e.g. 1 minute) to minimise the possibility of fraudulent use. Therefore the user should request the authorisation just as they are about to pay for their purchase to avoid the authorisation expiring before the customer has had time to scan it. The authorisation code 106 may include data indicating the maximum value authorised for this transaction, to be used by the payments terminal 107 to restrict the transaction value it will accept.

The original authorisation code 106, once decoded, is then passed to a payments terminal 107 to which the scanner 110 is connected via the communication cable 111. Alternatively the scanning device might simply pass the image data of the optically scannable image to the payments terminal 107 for decoding in the payments terminal.

In the payments terminal 107 the authorisation code is associated with the other purchase transaction information such as the purchase price, vendor identification etc. Finally the customer enters another piece of personal identification, such as a PIN or biometric information (e.g. finger print) into the payments terminal 107 (e.g. via the key pad 108) and the purchase transaction data 113 is sent to a settlements service 112 (optionally via the intermediary service provider 104).

When the settlement service receives the purchase transaction details 113 from the vendor's payments terminal 107, it passes the details 114 including the single use authorisation code to the financial service provider 102 to authorise the purchase transaction.

Once the settlement service 112 receives validation 115 from the financial service provider 102 it will arrange settlement by requesting that the financial service provider 102 transfer 116 the transaction value, less any service fees to be collected, to the vendors account 117 at their designated financial institution (established in the service agreement between the settlement service and the vendor). The financial service provider 102 will also forward the settlement fee, which is part of the retained fees, to the settlement service 112. The settlement service 112 may also be the vendor's financial service provider 117 or it may be a third party settlement service provider.

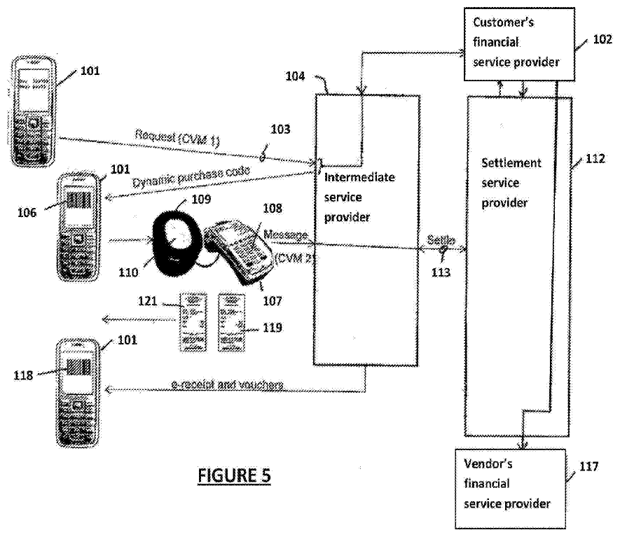

While the transaction described above involves transmitting the request for the payment authorisation by the customer to the financial service provider from the customer's mobile phone 101, using an SMS message, it may also be transmitted from the customer's mobile phone as an email message either as text or an attachment, by a message sent via Unstructured Supplementary Service Data (USSD) or via a web application running on a smart phone and accessing a secure server via the internet. The authorisation code may be a text based code such as an encoded character string (described below) sent via SMS, USSD, email or via a web server and web application, but may also be a conventional 1D or 2D barcode (see FIG. 5) displayed on a smartphone and transmitted as an attachment to an SMS or MMS message or an email or communicated to and displayed by a web application in communication with a web server. Other than for the type of optically readable code used, the process shown in FIG. 5 is essentially identical to that of FIG. 1.

Communication between the financial service provider 102 and the customer's phone 101 and between the vendor's payment terminal 107 and the settlement service provider 112 may be via an intermediary service provider 104, in which case the intermediary service provider may provide an encoding service whereby it receives an authorisation code from the financial service provider 102 and codes it in an optically readable image format that is appropriate for the type of mobile phone 101 used by the customer. The intermediary service provider 104 may also decode messages from the customer's phone 101 before relaying them to the financial service provider 102. The payment terminal 107 or the optical scanning device 109 may decode the optically displayed image of the authorisation code to reveal the original authorisation code created by the financial service provider 102 before adding it to the purchase transaction data transmitted to the settlement service.

The settlement service 112 may also send a receipt which may be a printed receipt 212 printed on the payments terminal 107 and/or an electronic receipt delivered to the customer's phone 101 (possibly through the intermediary service provider 104) and may show details such as the vendor, the purchase transaction number and value of the purchase transaction. The receipt may be accompanied by vouchers or other promotional material in the form of optically readable codes 118 using similar coding techniques to those used for the authorisation code or they may be paper vouchers 119 printed on the payments terminal 107. In either case the vouchers 118, 119 will display the same optically readable code.

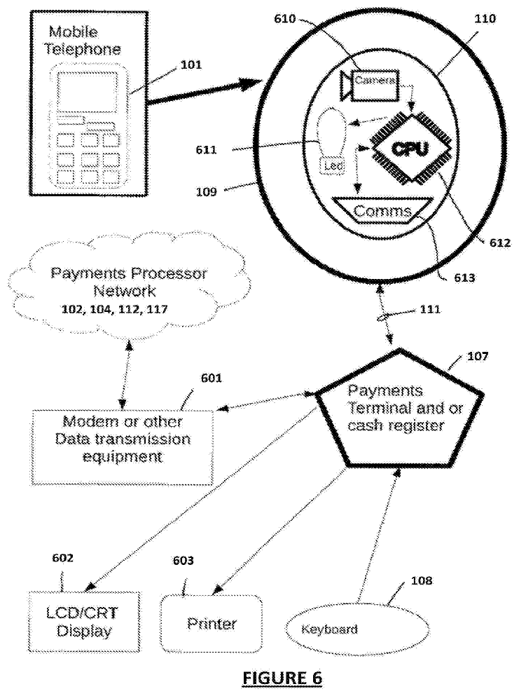

The arrangement of equipment at the point of sale is illustrated in FIG. 6. The scanner 109, includes a processor 612 that controls the operation of the scanner, and in particular the processor 612 operates a LED illumination system 611 located behind the scanning window 109, which is switched on when scanning is enabled to illuminate the display of the customers phone 101 to enable operation with non-backlit phone displays. The illumination level is set to enable adequate illumination of non-backlit phones displays while not producing excessive glare to interfere with the scanning of phones having backlit displays. When scanning is enabled, the camera 610 is also turned on to look for detectable optically readable codes or images 106, 118. If the detected optically readable code is a voucher 118, the code will be decoded in the scanner 109 and passed to the payments terminal 107 for processing according to the vendors rules and if it is a payment authorisation 106 it will be decoded to the issuers original code and passed to the payments terminal 107 for incorporation in a transaction as previously described. The processor 612 communicates with the payments terminal 107 using a conventional communications device 613 via the cable 111 previously described.

The payments terminal 107 is a standard device used to process other payment types such as credit card payments and will generally include a keyboard 108, a printer 603, an LCD or CRT display 602 and a modem or other communications equipment 601 for communication with a payment system 102, 104, 112, 117 as previously described via a dedicated line, a dial up telephone connection or an internet connection.

In some instances the item purchased by the customer will be a ticket or other prepayment voucher (e.g. a single use theatre ticket, a single or multiple use transportation ticket, a gift certificate etc.). Such prepayment vouchers may be purchased using the abovementioned payment method or any other payment method but may be delivered as an optically readable code 118 transmitted to the customer's mobile phone 101 as described above or in the case of a gift voucher they may be delivered to another phone such as the phone of a specified gift recipient. Alternatively the voucher could be a physical voucher 119 such that a machine readable code is carried on a piece of paper or other suitable media. The code could be encoded optically such as by simply printing the same code used for the phone displayed optically scannable images described above, or could use other forms of recording such as a magnetic stripe on a paper or plastic ticket.

Whether on a physical ticket or displayed on a mobile phone display such vouchers 118, 119 the voucher must be machine readable. For the remainder of this description we will use the example of an optically scannable image which may be read on the scanner 109 and decoded in the processor 612 as discussed above. However other readers for reading other encoding types such as magnetic stripes could be substituted or operated in parallel.

The generation of the voucher will require the contacting of a service (a server) that can issue a voucher code 118, 119 that is readable and recognisable as valid and convertible by the scanner 109. In the examples described with reference to FIGS. 1 & 5 above, the code issuer may be the intermediate service provider 104 but could equally be a party independent of the basic settlement process and connected to the process via any of the other service providing participants including directly with the vendor. In fact the issuing of the vouchers need not be associated with the process described above and could be a separate process altogether. However for simplicity we will use the example of the vouchers 118, 119 described above.

While the vouchers may be on paper or other physical media or electronically displayed they should be machine readable. However they could be scanned other than optically such as on a magnetic stripe (magnetic stripe rail or bus ticket etc.).

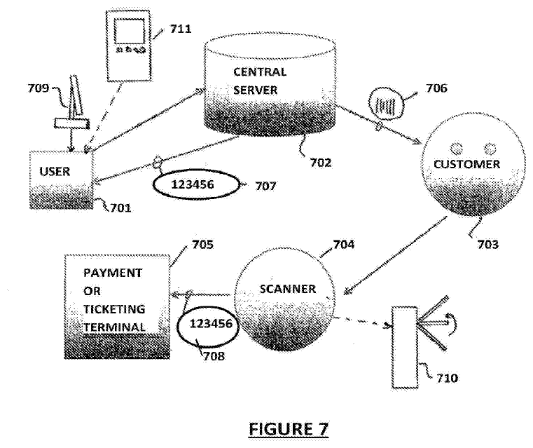

The server which issues the vouchers 118, 119 will implement the sequence outlined below. In this sequence the ‘user’ is a ticketing system or payments system provider. The ‘customer’ is the end customer of the system. This sequence creates a time limited validity period for each ticket issued by the server. The sequence as illustrated in FIG. 7 comprises:

1. The user 701 contacts a central server 702 to generate a ‘token’ 706 to fulfil a purchase by a customer 703. This token 706 is an encrypted message (such as a voucher number X1) which may be issued as an optically scannable image that can be sent directly to a customer's phone (e.g. an encoded character string that can be sent via SMS or a 1D or 2D bar code etc. that can be sent via SMS or dedicated application on a smart phone as discussed above), or it may be a similarly encoded physical ticket that is printed at a point of sale or on a printer of a customer's home computer.

2. The user 701 does not receive a copy of the token 706. Instead the user receives one or more different codes (A1, A2 etc.) 707. These codes could be a ‘hash-based message authentication code’ (HMAC) that are obtained by ‘hashing’ the ‘token’ 706 with secret keys.

3. The secret keys are known to the optical scanner 704 (similar to the scanner 109 in FIGS. 1 & 5). When the optically scannable encrypted message is scanned, the processor 612 (refer to FIG. 6) of the optical scanner 704 is able to perform the same HMAC computation and return this hashed code (A1, A2, etc.) 708 to the payment or ticketing terminal 705 of the user 701, which compares the code from the scanner 704 with the codes received from the server 702.

4. Importantly, a different secret key is used for each time period. For example, if a monthly time period is used, then the scanning device will use a new secret key every month. This means that when token ‘X’ is scanned in month 1, the value ‘A1’ is returned by the scanning device. When that same token ‘X’ is scanned in month 2, the value ‘A2’ is returned.

5. The user 701 will receive one or more codes A1, A2, etc. for each token issued depending on the number of periods that the user wishes the token to operate. So in the example in paragraph 4. above, if the user 701 wishes the token to be valid for two periods they will receive two codes A1 & A2 which are loaded into the payment or ticketing system 705 and used to compare with the code 708 returned by the scanner to determine validity of the scanned code. If the ticket is scanned in the third months and returns the code A3 which was not one received by the user 701 when requesting the token be issued, the scanned code will not match a valid code held by the user and will be rejected by the user.

The period of validity of a token may vary depending on the application. For example, in the case of a theatre ticket each period may correspond to a single show time whereas for a rail ticket the period might be a day or a month.

In FIG. 7, the user 701 may be a vendor's point of sale system or user sales server. The process may be initiated in various ways such by a physical presence of the customer at a point of sale counter where a customer service staff initiates the purchase via a sales terminal 709 connected to the user sales server 701, a customer performing an online transaction with an online shop via their home computer or portable device 709 connected to the users sales server 701 via the internet, or the customer initiating a transaction at vending machine 711 connected to the user sales server 701,

When the token is a ticket for entry or travel, the scanner 704 may optionally be connected to an entry barrier or turnstile 710, such that scanning a valid ticket will release the turnstile for entry. When the token is a discount voucher or gift certificate the scanner 704 will pass the token to a point of sale system 705 where it will cause a credit to be created in relation to a transaction being processed on the point of sale system 705. The point of sale system 705 may be the same system as the user sale system 701 or may be a different system.

As mentioned above, the optically readable code can be any one of several types such as 1D and 2D barcodes or it may comprise an encoded character string specifically formatted for optical reading. A description of such encoded character strings follows, however it will be noted that encoded character strings formatted for optical reading have a variety of uses and the following description makes reference to other uses such as ticketing applications.

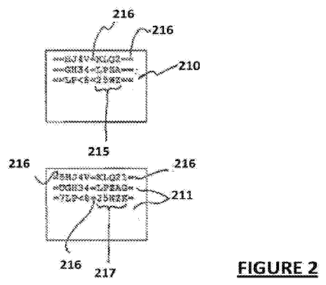

Encoded character strings are encoded from primary encoded data such as a payment authorisation code, a ticket number or a discount voucher code, The encoded information or “initial data” is transformed into a portable alphanumeric string geometry 210 (“encoded character string”) in the format which is illustrated in FIG. 2. Such an alphanumeric string is easily transmitted wirelessly to all messaging-supporting mobile devices whereupon it may be optically scanned and reliably decoded back to the original encoded information, for purposes such as payment authorisation, admission, identification of person, identification of a customer profile, etc. In one example of FIG. 2, nine to fifteen digits of information are transmitted as a message that results in 3 lines of text 210. Each line has two sets 215 of four or five alphanumeric characters, each line bounded by a special marker character 216. The sets are separated by the same special marker characters 216, here the symbol “=”. In another example of FIGS. 2, 216 to 18 digits of information are transmitted as a message that results in 3 lines of text 211. Each line has two sets 217 of five alphanumeric characters, each line bounded by a special marker character and the sets separated by a distinctive single special marker characters, here the symbol “=”. The “=” is considered distinctive because it is least likely to be confused at a visual level with any other character. Alternatively, other similar methods can be used to utilise the geometric uniqueness of certain alphanumeric characters to define recognised forms of encoded character string for efficient optical processing. These include alternating patterns such as alternating between uppercase to lowercase to uppercase on character progression along a line (e.g. aBcDmPdYoG), known patterns such as using pre-defined multi-character sequences (e.g. b57-z82-p45-), and location-sensitive character mapping where the characters used for mapping is a function of each character's own x and y coordinates in rows and columns. As an example to the location-sensitive character mapping, one mapping rule could be that third row characters should only contain uppercase letters between M and Z (e.g. Line 1=29183902, Line2=addcedpqz, Line3=MNPZZQRM). These similar methods are all designed to create geometric patterns in the raw captured image of the encoded character string that the decoding system can use as hints to locate the code and decode the image. This unique method of applying alphanumeric geometry is a key contributor to create a system of encoding and decoding alphanumeric data with satisfactory scan reliability and speed for commercial deployment.

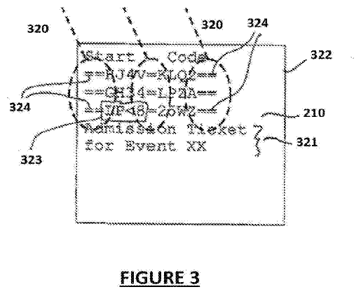

As shown in FIG. 3, an example of a client display 322 displays an encoded character string which is formatted for scanning. In this case the encoded character string represents an admission ticket for an event. The encoded character string in FIG. 3 shows the use of transmitted special characters 20 in the encoding character set that are easily recognisable to act as markers in the rectangular display geometry so that the image capture and processing algorithms can more efficiently recognise and decode the image. In this example, the symbol character “=” (ASCII 20) is used as a boundary symbol. Sets 323 of four other characters such as alphanumeric characters are located between separated boundary characters 320. The displayed message may include non-coding descriptive text 321 located outside of the target area defined by the 4 corner located special characters 324.

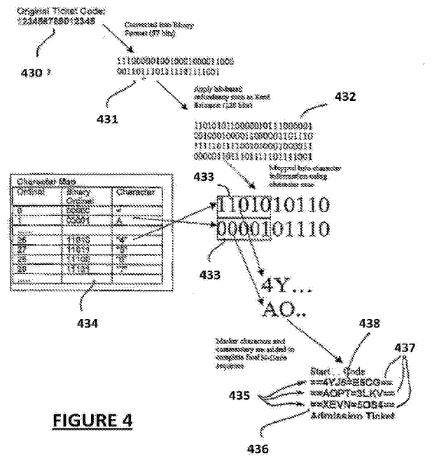

As shown in FIG. 4, the method requires that information in the form of an original n-digit ticket code 430 be converted into binary format 431 using a published bit-based redundancy algorithm. A suitable algorithm is Reed Solomon, but this is not mandatory. For instance, a ticket code of 123456789012345 will be converted into binary: 00000100100010000110000011011101111101111001, which is now a 47-bit binary number. As the original number has 15 digits, it will be converted into an encoded character string formation as illustrated in FIG. 3.

One typical encoded character string contains 24 5-bit data characters. In this example, the encoded character string can carry a total of 24×5=120 bits of information. The 47-bit binary number is converted into a 120-bit number 432 using Reed Solomon bit-based data redundancy. This number will is then separated into 24 sequential lots 433 of 5 bits, and each 5 bits will now form a 5-bit binary word, and each of these words is mapped into a 5-bit data character from a character map 434. Note that the number of binary bits in each word does not exceed the number of bits required for any character in the map 434.

The following 5-bit character map is a suitable character map for 5-bit characters (there are 2 to the power of 5, which equals 32, characters in this map):

<ABCDEFGHJKLMNOPQSTUVWXYZ2345679

Note that the alphanumeric characters I, R, 0, 1, and 8 have been removed because they bear resemblance to other characters, potentially causing errors in scanning and decoding. Note that neither 5-bit nor the particular character set above are mandatory to the invention, they are examples. Thus, a 5-bit word that is of value 01010 will map to the 11^{th} character in the set (01010=decimal ten). Allowing for “0” to be the first character, 01010 will map to the 11^{th}, which would be “K”. In this example all alphabetic characters are upper case.

Using this method, a 120-bit string would be encoded into something that looks like:

6WJ5E5CG<5PT3LKVXEVN5OS4

This raw character sequence is divided into three lines of characters 435 and each line is demarcated by an initial double equals sign “= =” 436 and a terminal double equals sign “= =” 437. Each line is divided in half by a single equals sign “=” 438. Line feed command characters are inserted as required to provide the final display geometry.

Thus, and as suggested by FIGS. 2 and 3, the resultant encoded character string will look like:

= =6WJ5=E5CG= =

= =<5PT=3LKV= =

= =XENN=5OS4= =

This encoded character string is now ready to be transmitted. Note that any descriptive text before and after the encoded character string will eventually be ignored by the data capture software due to the use of the boundary symbols “=”. In the following example, the first and last lines “Start Code” and “Admission Ticket” will eventually be ignored by the client side decoding procedure.

Start Code

= =6WJ5=E5CG= =

= =<5PT=3LKV= =

= =XEVN=5OS4= =

Admission Ticket

The above type encoded character string is transmittable wirelessly onto mobile devices, via network-specific protocols such as SMPP, SS7 or SMTP over air. This utilises existing network infrastructure of network carriers. As it is in plain text, the content will arrive unaltered, and will display highly consistently across different mobile devices, as it is designed for human eye to read. Certain mobile devices display double line-feeds as single and certain other devices display them as doubles. Double line-feeds must be eliminated before sending, to ensure the image is single line-spaced. Double line-spaced encoded character strings are not scannable.

Once received by a client device and displayed, the encoded character string is captured using an image capture device such as a digital camera or a video camera. The device may provide a lighting source that emulates the lighting of a “cloudy day” which is essentially diffused lighting, in order to minimise lighting highlights or “spots” on the capture image of the client device (phone or PDA etc.) screen that would have resulted from direct lighting sources. These lighting spots may obscure part of the image.

The frame rate and data capture speed must be sufficiently fast to transmit colour images of the mobile phone screen. Optionally the capture equipment has a motion detect sub-routine that triggers the capture device to take a static “photo” of the stationary mobile phone screen, once it is determined that the mobile phone has indeed become stationary, or within acceptable range of movement that satisfies the definition of stationary. Without this option, software will be used instead to determine from the live video feed whether the phone has arrived and become stationary. This type of image processing software library is widely published and easily obtained and implemented.

The present methods apply statistical and mathematical algorithms to convert the captured colour image of various types mobile phone screen available in the market into a black and white image that a generic optical character recognition engine (OCR) can easily decode into text guesses.

Various methods are used to locate the code within the scan area, and to pick the characters out of the background noise, including detecting a centre of the image, deskewing, target area determination, contrast processing, optical character recognition (OCR), Redundancy checking and code identification and validation. Methods of performing these functions are referred to in PCT Patent Specification WO 2005/083640 (PCT/AU2005/000276).

The central server may be embodied in hardware, software, firmware or a combination of hardware, software and firmware. In a hardware embodiment, the central server may comprise one or more processors, which may be distributed processors on a network, and one or more memories operatively associated with the one or more processors which may also be distributed. The memories may store instructions, applications and/or programs that, when executed by the one or more processors, cause the central server to perform the steps of the central server described above. The one or more memories may also store data, such as the tokens, hash keys, etc, as well as any intermediate or final processing results that are used in performing the functions of the central server described above.

Similarly, the user terminal and/or scanning device may be embodied in hardware, software, firmware or a combination of hardware, software and firmware. In a hardware embodiment, the user terminal and/or scanning device may comprise one or more processors, which may be distributed processors on a network, and one or more memories operatively associated with the one or more processors which may also be distributed. The memories may store instructions, applications and/or programs that, when executed by the one or more processors, cause the user terminal and/or scanning device to perform the steps of the user terminal and/or scanning device described above. The one or more memories may also store data, such as the tokens, hash keys, modified tokens, etc, as well as any intermediate or final processing results that are used in performing the functions of the user terminal and/or scanning device described above.

The central server, user terminal and scanning device may communicate on any suitable telecommunications network including direct connections, serial lines (e.g. USB), local area networks, wide area networks (e.g. internet) and/or wireless networks using any suitable protocols including IP protocols, wireless or mobile communications protocols, file transfer protocols (FTP), etc.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-82.(canceled)

83. A method of authenticating a token which has a time limited validity period, the method comprising:
providing a system including a user terminal associated with a user, a server operatively coupled to the user terminal, and a scanner operatively coupled to the user terminal, wherein the scanner is adapted to store a secret key which is associated with a time period and which is shared with the server;
the user operating the user terminal to generate a user request for issuance of a token and sending the user request to the server;
the server receiving the user request and sending a customer token to a customer device and a modified token to the user terminal, wherein the modified token is a modified version of the customer token, and wherein the customer token is displayed on the customer device in the form of an optically scannable image;
operating the scanner to scan the customer token displayed on the customer device;
using the secret key to modify the customer token scanned from the customer device pertaining to a time period at which the customer token is scanned to produce a modified customer token, and sending the modified customer token to the user terminal; and
at the user terminal, receiving the modified customer token and comparing the modified customer token to the modified token sent from the server to determine whether the modified customer token is valid.

84. The method of claim 83, wherein the time period of validity of the token is the duration of a single event.

85. The method of claim 83, wherein the time period of validity of the token is a period of during which the token may be used a plurality of times.

86. The method of claim 83, wherein the user terminal is a vendor's point of sale system.

87. The method of claim 83, wherein the user is a user sales server.

88. The method of claim 87, wherein the user request for issuance of a token is generated by operation of a point of sale terminal connected to the user sales server.

89. The method of claim 87, wherein the user request for issuance of a token is generated by operation of an online transaction with an online shop via a computer or portable device connected to the user's sales server via the internet.

90. The method of claim 87, wherein the user request for issuance of a token is generated by a customer initiating a transaction at a vending machine connected to the user sales server.

91. The method of claim 83, wherein the token is a ticket for entry or travel, and the scanner is connected to an entry barrier or turnstile and scanning a valid ticket releases the turnstile for entry.

92. The method of claim 83, wherein the token is a discount voucher or gift certificate, and the scanner passes a code of the token to a point of sale system where it causes a credit to be created in relation to a transaction being processed on the point of sale system.

93. The method of claim 83, further including performing a transaction between a customer and a vendor using a customer's mobile phone as an authorization device, the transaction involving:
a customer placing a request for payment authorization with a financial service provider;
the customer receiving a single use authorization code from the financial service provider on the customer's mobile phone, and the authorization code displaying on the customer's mobile phone as an optically readable image; and
the customer scanning the optically readable image on an optical scanning device associated with a vendor's payments terminal to authorize the transaction, enabling the single use authorization code to be communicated to a settlement service for settlement of the transaction.

94. The method of claim 93, wherein the request for payment authorization is issued by the customer to the financial service provider from the customer's device, which comprises a mobile or cellular phone or a smart phone.

95. The method of claim 93, wherein the authorization code is encoded into a text based code, an encoded character string, or, a 1D or 2D barcode displayed on a smartphone.

96. The method of claim 85, further including authorizing a transaction between a customer and a vendor, wherein the customer's device includes a mobile phone as an authorization device, and wherein the server is the server of a financial services provider or a settlement service.

97. The method of claim 96, wherein the settlement service settles the transaction by arranging a funds transfer from the financial service provider to the vendor.

98. The method of claim 97, wherein the funds transfer is from the financial service provider to a vendor's account at a financial institution.

99. A system for authenticating a token which has a time limited validity period, the system comprising:
a user terminal associated with a user,
a server, operatively coupled to the user terminal, and
a scanner, operatively coupled to the user terminal, and adapted to store a secret key which is associated with a time period and which is shared with the server;
wherein, in use:
the user initiates a user request for issuance of a token;
the server receives the user request and sends a customer token to a customer device and a modified token to the user terminal, wherein the modified token is a modified version of the customer token, and wherein the customer token is displayed on the customer device in the form of an optically scannable image;
the scanner scans the customer token displayed on the customer device, uses the stored secret key to modify the customer token pertaining to a time period at which the customer token is scanned to produce a modified customer token, and sends the modified customer token to the user terminal; and
the user terminal receives the modified token sent by the server, receives the modified customer token from the scanner, and compares the scanned modified customer token with the modified token to determine whether the modified customer token is valid.

100. The system of claim 99, wherein the scanning device stores a plurality of secret keys corresponding to a plurality of periods and wherein the scanning device modifies the customer token using a secret key pertaining to a time period at which the customer token is scanned.

101. The system of claim 99, wherein the scanning device is configured to scan the customer token from the customer device.

102. The system of claim 101, wherein the customer device is a mobile phone of the customer, and the scanning device is configured to scan the customer token from a text message displayed on the mobile phone.

103. The system of claim 99, wherein the server comprises at least one processor and at least one memory operatively associated with the at least one processor, wherein the server programmed to:
receive a request requesting issuance of a token to a customer; and
issue a machine readable customer token directly or indirectly to the customer in response to receiving the request and issue one or more modified versions of the token to a user terminal, each modified version of the token being associated with a different time period of validity of the token.

104. The system of claim 99, wherein the user terminal comprises at least one processor and at least one memory operatively associated with the at least one processor, wherein the user terminal programmed to:
receive one or more modified tokens from the server, the one or more modified tokens derived from a customer token, each modified version of the token being associated with a different time period of validity of the token;
store the one or more modified tokens;
receive a scanning device token from the scanning device that is derived from the customer token;
compare the scanning device token with the one or more modified tokens; and
indicate that the scanning device token is valid if the scanning device token matches at least one of the one or more modified tokens.

105. The system of claim 99, wherein the scanning device comprises at least one processor and at least one memory operatively associated with the at least one processor, wherein the scanning device configured to:
scan a customer token;
store a secret key which is shared with the server that issued the customer token, the secret key corresponding to a time period;
modify the customer token using the secret key pertaining to a time period at which the customer token is scanned; and
provide the modified token to the user terminal.
